(19) United States
(12) Patent Application Publication
(10) Pub. No.: US 2011/0047183 A1
(43) Pub. Date: Feb. 24, 2011

(54) CHAIN OF CUSTODY MONITORING AND MANAGEMENT

(75) Inventors: Brian Ford, Oxton (GB); Patrick James Newton, Middlesex (GB); Stewart Francis Ross, Berkshire (GB)

Correspondence Address: PEPPER HAMILTON LLP, ONE MELLON CENTER, 50TH FLOOR, 500 GRANT STREET, PITTSBURGH, PA, 15219, US

(73) Assignee: HELVETA LIMITED, Oxfordshire (GB)

(21) Appl. No.: 12/546,407

(22) Filed: Aug. 24, 2009

(51) Int. Cl. G06F 17/30; G06Q 10/00

(52) U.S. Cl. 707/783; 705/28; 707/E17.044

(57) ABSTRACT

A system for monitoring and managing chain of custody information for an asset or a group of assets through various stages of asset transport or transformation. The system includes a server configured to assign an asset identifier relating to each specific asset, an asset record stored on a computer readable medium and linked to the asset identifier, the record configured to store data linked to a specific asset, a series of modules, each module stored on a computer readable medium, the modules comprising instructions configured to instruct a processor to access and modify the asset record as well as to establish a series of rules for managing the asset, and at least one supplier computing device operably connected to the server, the computing device configured to access at least one of the series of modules, thereby allowing a user to access and modify the asset record.

### BACKGROUND

The present invention relates to chain of custody monitoring and management. More particularly, it relates to a network based integrated system for tracking and monitoring assets moving through an entire supply chain. Specifically, the present invention relates to the handling of assets moving through an entire supply chain where rules of legal or commercial compliance apply, and where decisions may need to be taken at any point within that supply chain including disconnected mobile operation environments where there may be no regular, consistent access to a communication network.

Recent history has seen a significant increase in the industrialization of previously un-industrialized or even un-civilized areas. Along with this industrialization, global commerce has increased rapidly as well. Faster, cheaper methods of transporting, advertising, and selling goods have developed, providing for a truly global marketplace.

Along with the development of the global marketplace, there has been a significant increase in the importance that individuals, companies and governments attached to product origin, product production methods and product quality. This increasing importance has resulted from a greater awareness of environmental damage caused by production activities such as deforestation caused by logging and pollution caused by production facilities. Similarly, concern over product development and production has arisen based on concerns over working conditions for employees producing the products, employee wages and safety, and other various concerns.

Historically, there has been little or no concern by consumers as to product information. This information was generally not provided to the consumers, and if it was, it was merely a paper trail that could have been forged or changed at many points along the production path of a product. However, with an increased global awareness, and a growing movement for the preservation of natural resources, consumer attitude is shifting. For example, many consumers are now concerned as to whether the materials used in manufacturing a product, or the processes used to produce a product, have caused any environmental damage. For example, a consumer may be concerned that the wood used to produce a certain object (e.g., a piece of furniture) may have come from a protected forest. Similarly, some producers of goods are becoming concerned with product origin and product production information. For example, an organic farmer may spend a significant amount of money on organic production methods as compared to a conventional farmer. The organic farmer labels his goods as organic, and charges a slightly higher price to offset the higher expenses. However, without a way of tracking production of the goods, a consumer may not trust the items to be organic, or, the conventional farmer may label his goods as organic and charge a lower price. Without product origin and production information, there is no way for a consumer to confirm what goods are as they are advertised, i.e., is produce truly organic or is the wood used to manufacture an item from a “green” forest, or a forest that requires replenishment of trees as they are chopped down. Paper records or certifications relating to product origin are difficult, or in some cases impossible, for consumers to obtain or remotely access.

As such, the paper based certification and tracking systems are riddled with inherent drawbacks. Primarily, paper based certification have become increasingly discredited as being unable to combat fraud and manipulation of information along a chain of custody. A chain of custody refers to the chronological documentation showing the custody, control, and transfer of a specific asset. Similarly, a supply chain is the system of organizations, people, industries, suppliers, distributors, etc. that are involved in the chain of custody for the specific asset. Typically, the supply chain for an asset outlines each person or organization involved in the lifetime of an asset from initial supplier to a consumer.

It is becoming increasingly common that both companies and individual employees of those companies must ensure strict compliance with industry wide regulatory frameworks and commercial contracts governing the handling of products throughout an entire supply chain. Such frameworks may include government imposed legal requirements, industry sector-based requirements or best practices, and industry sector-based rules of certification. As it is, paper based certification systems simply allow too much variance between record keeping entities, and provide too many opportunities for fraud and document falsification to provide an adequate chain of custody monitoring and management system for commercial products. In particular, paper based certification systems cannot, in real time, verify adherence to asset management rules for single assets, across groups of assets, or for processes that must apply to the entire supply chain.

### SUMMARY

Before the present methods are described, it is to be understood that this invention is not limited to the particular systems methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to an “asset” is a reference to one or more products and equivalents that may be distributed to various suppliers and/or manufacturers known to those skilled in the art, and so forth. Unless defined otherwise, all technical and scientific terms used herein have the same meanings as commonly understood by one of ordinary skill in the art. As used herein, the term “comprising” means “including, but not limited to.”

In one general respect, the embodiments disclose a system for monitoring and managing chain of custody information for an asset or a group of assets through various stages of asset transport or transformation. The system includes a server configured to assign an asset identifier relating to each specific asset, an asset record stored on a computer readable medium and linked to the asset identifier, the record configured to store data linked to a specific asset as the asset moves through various stages of asset transport or transformation, a series of modules, each module stored on a computer readable medium, the modules comprising instructions configured to instruct a processor to access and modify the asset record as well as to establish a series of rules for managing the asset, and at least one supplier computing device operably connected to the server, the computing device configured to access at least one of the series of modules, thereby allowing a user of the supplier computing device to access and modify the asset record.

In another general respect, the embodiments disclose a method of monitoring and managing chain of custody information for an asset or a group of assets through various stages of asset transport or transformation. The method includes the steps of: assigning an asset ID to each asset; linking an asset record to the asset ID, wherein the asset record is stored on a computer readable medium and configured to store data linked to a specific asset as the asset moves through various stages of asset transport or transformation; accessing the asset record via a view module, wherein the view module is a set of instructions stored on a computer readable medium configured to instruct a processor to perform a specific task; managing the asset record via an audit module, wherein the audit module is a set of instructions stored on a computer readable medium configured to provide real time alerts based upon a comparison of a series of rules for managing the asset and any incoming or stored data relating to activities involving the asset; updating the asset record via the view module; and accessing and viewing the updated asset record via the view module.

### BRIEF DESCRIPTION OF THE DRAWINGS

Aspects, features, benefits and advantages of the present invention will be apparent with regard to the following description and accompanying drawings, of which:

FIG. 1 illustrates a logistical arrangement of components for a chain of custody monitoring and management system;

FIG. 2 illustrates an exemplary network for use by a producer for defining, monitoring and managing chain of custody information;

FIG. 3 illustrates a detailed view of a centralized server component for use in the exemplary network illustrated in FIG. 2; and

FIG. 4 illustrates a flowchart illustrating an exemplary process for monitoring and managing chain of custody information.

### DETAILED DESCRIPTION

The method and system described herein center on the monitoring of an asset and management of chain of custody information relating to that asset. The asset may be transformed as it moves through the supply chain. For example, asset transformation from the timber industry may be a freshly fallen tree to sawn logs from the fallen tree, the sawn logs to individual wood planks, the wood planks to more detailed components, and the detailed components to a fully finished processed product constructed from the original tree or trees. At each stage of asset transport or transformation, asset information may be added or updated, resulting in a high degree of control over chain of custody information relating to the asset. A record containing a complete backward and forward linkage of all parts of the asset is maintained through all stages of transport or transformation across the entire supply chain. Examples of asset transformation may include, but are not limited to, splitting (e.g., trees to logs), joining (e.g., pallets to containers), and mixing (e.g., factory processing). It should be noted that the methods and systems described herein are also easily scalable from a single asset to multiple assets across a supply chain. Individual records may be linked together such that a relationship between assets is established, thereby providing a uniform application of the rules and regulations across all related assets.

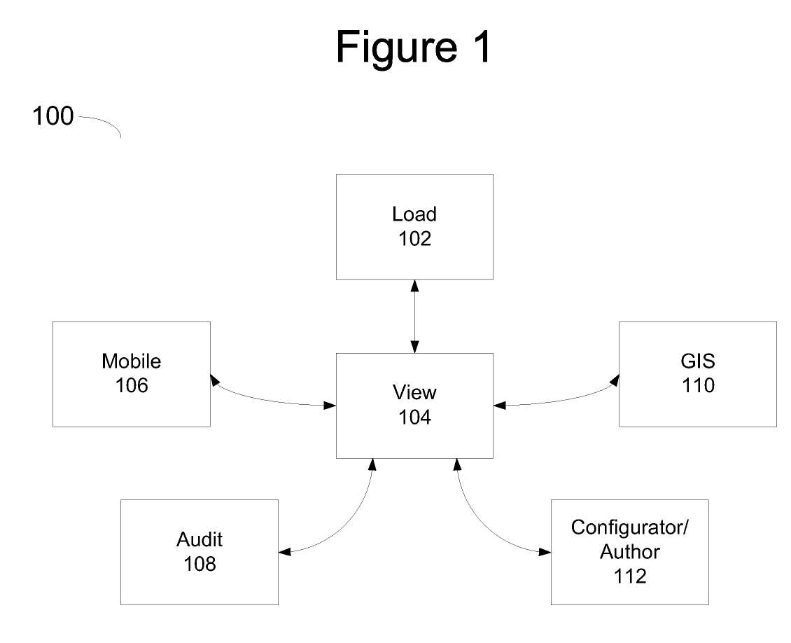

FIG. 1 illustrates an exemplary system 100 that may be used for chain of custody information monitoring and management. System 100 may include a number of modules that may be integrated on a single server, or distributed across various servers depending on the application. The modules interact with each other to provide system 100 with the functionality to perform the monitoring and management of chain of custody information.

Load module 102 may be the module where data is imported. Load module 102 may be operably connected to the other modules through view module 1.04. Load module 102 may be the central data handling and processing module, specifically configured to import data, perform any verification needed of the data (e.g., according to government rules or regulations), synchronize any incoming data to update previously stored data, and transform previously stored data to reflect any additional changes to the recorded asset. The rules and regulations may be defined by a government agency, global standards organization, industry association or other ruling body. The rules and regulations may define set of parameters that should be obeyed during asset management, transport and transformation throughout the entire supply chain. Rules and regulations are discussed in additional detail in the following discussions. Load module 102 may further be configured to link to other monitoring systems to perform data verification and to determine data compliance across systems.

View module 104 may act as a hub operably connected to all modules of system 100. Specifically, view module 104 may be configured to provide a login to users, allowing users to access a role based portal. For example, if a user is registered as a supplier, upon login the user would have access to the supplier based portal. There the user may be able to access specific web based data entry forms pertaining to a specific asset, view chain of custody information, see organized asset collections the supplier may be responsible for, manage documents related to the assets (e.g., customs documents, various permits and licenses), as well as produce reports relating to the assets. Similarly, if a user is registered as a product producer, the user may have limited access to the various features of view module 104. The web based forms may be specifically tailored to a producer, as opposed to the forms provided for the supplier. Similarly, other functions may be altered such as report generation and available documents. It should be noted that supplier and producer are shown by way of example only, and actual systems may be customized to include additional and/or alternate classes of users, such as transporter, distributor, seller, etc.

Mobile module 106 may be operably connected to view module 104. Mobile module 106 may incorporate several key data capturing features, such as remote data capture from integrated mobile devices. This remote capture may be via wireless networks, cell networks, or any other mobile data transfer network. The collected data may be asset specific such as identification number for the asset (asset ID), GPS information indicating where the information was obtained if the mobile device has an integrated GPS unit. Similarly, the mobile module may allow outside access to the functionality of the view module 104, specifically user access to the above discussed features.

Mobile module 106 may also be configured to communicate with and capture data from devices operating in disconnected areas where there may be no regular access to communication networks. This disconnected mobile devices may include a smaller subset of the rules and regulations assigned for a specific asset transport or transformation. This allows a user of the disconnected mobile device to enter information and make decisions relating to a particular asset on the disconnected device while still abiding by the rules and regulations assigned for that particular asset transport or transformation. When possible, the disconnected mobile device may be connected to a communication network where it transfers data to the mobile module 106. The mobile module 106 captures and collects this data as before with the standard integrated mobile devices.

Additionally, mobile module 106 may maintain information about specific mobile devices such as a database of registered and trusted devices. The mobile module 106 may also maintain various access platforms for specific mobile device, allowing multiple mobile devices to access the view module 104. For example, a first set of specific applications may be maintained for mobile devices running a first operating system (e.g., Microsoft Windows®), and a second set of specific applications for a second operating system (e.g., an open source operating system). This provides a-higher level of mobility as multiple devices can access system 100 regardless of manufacturer or device type.

Similarly, mobile module 106 may maintain software upgrades for mobile devices, and manage the pushing of these software upgrades to the various mobile devices. This provides for a modular system where software upgrades may be quickly distributed to all devices registered and permitted to access the system.

Audit module 108 may be operably connected to view module 104, thereby providing access to the other connected modules. Audit module 108 may be configured to provide real time alerting to devices connected to system 100 such as a mobile device connected to mobile module 106. These alerts may be based upon evaluations of stored or incoming data, such as unexpected results based upon received data as compared to what is expected based upon previously stored data or stored asset models. For example, if in tracking an asset, an expected number of products is to be produced based upon the volume of the asset (e.g., board feet of lumber), and the actual number produced is outside of a tolerated amount (e.g., 10% above or below expected number), an alert may be issued and sent to mobile devices tracking this particular asset. Similarly, workflow progress may be monitored and alerts sent to mobile devices tracking the particular asset.

Audit module 108 may detect and take action on supply chain conditions at a specific point in the supply chain, or on conditions or trends distributed across the entire supply chain. Audit module 108 may also oversee single assets, groups or related assets (e.g., through linked records as discussed above), or processes that apply across the entire supply chain. As mentioned above in the example of lumber related asset tracking, it may be possible to track changes in the volume of the lumber asset throughout all stages of transformation (e.g., freshly fallen tree to sawn logs made from the fallen tree, to planks cut from the sawn logs, to components made from the planks, to a fully finished, processed product constructed from the original fallen tree or trees), and initiate appropriate management activity (e.g., issuing an alert to management) should there be any unexpected change in volume.

Geographical information System (GIS) module 110 may be operably connected to view module 104 to provide GPS and tracking related information. Specifically, GIS module 110 may be configured to acquire GPS data related to an individual asset. For example, for a timber asset, the GPS information may relate to points of acquisition, forest boundaries, specific areas of logging, etc. The GPS data may further be updated after acquisition to track movement of the asset to show supplier and/or distributor movement of the asset.

Configurator/author module 112 may be operably connected to view module 104 and may provide a configuration feature for a person setting-up or managing system 100. Configurator/author module 112 may provide customization options such as configuration of user roles, languages, data and asset models, supply chain relationships, supply chain rules of management, pre-set forms and optional reports. As discussed above, each user role may have access to different options such as forms and reports. A user of configurator/author module 112 may establish these relationships as well as any other customization a purchaser of system 100 may require.

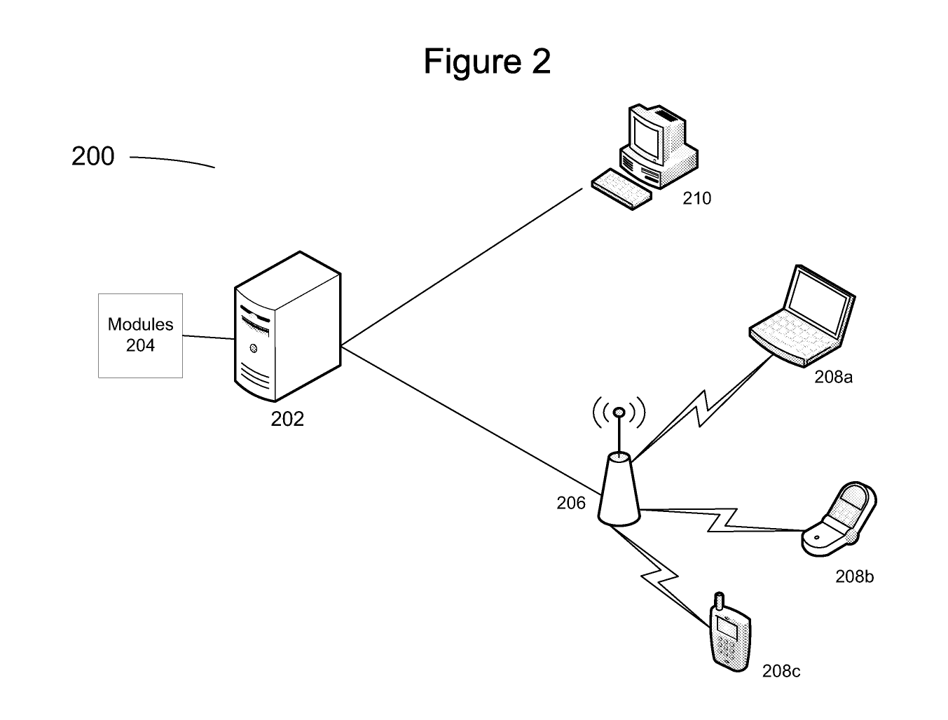

Operation of the individual modules, as well as system 100, will be further explained in the descriptions of FIGS. 2-4 below. It should be noted, however, that system 100 and the following explanation is merely given by way of an embodiment of an exemplary chain of custody monitoring and management system. Additionally, the modules of system 100 may be computer based applications or instruction sets stored on a computer readable medium, containing code for instructing a computer processor to perform certain tasks.

FIG. 2 illustrates an exemplary network 200 for use by a producer to define product origin and production information. Network 200 includes a centralized server 202 for storing modules 204 (e.g., the various modules discussed in FIG. 1, system 100) while permitting access from various vendor, supplier or producer computing devices 208a-c and 210 (for convenience, “supplier” will relate to all aspects of product manufacture and production, including vendors, suppliers, manufacturers, transporters, advertisers, etc.). It should be noted that while a single server is shown in this example, multiple servers may be used to host various modules, databases and information related to authorized suppliers and producers, asset IDs, and other related data.

Each supplier device may designate an assigned asset ID to an asset or a collection of assets, for example, a single fallen tree or a group of ten fallen trees (for convenience, an asset will relate to both a single asset and a batch of assets). However, to designate an asset ID, a supplier first receives the asset ID from an assigning administrative control. To communicate with an administrative control, a supplier may be authorized or “trusted” to access server 202 and modules 204. A suitable authentication and trust assigning process may be performed prior to any product production such that a supplier becomes trusted. For example, an agricultural supplier may pass a prior food safety and quality inspection to become trusted. Similarly, a forestry supplier may pass other permit and authorization requirements. The exact nature of trust varies from application to application and supplier to supplier, however, a level of trust may be maintained to ensure consumer confidence. To achieve continued trust, any authentication processes may be repeated over a period of time, for example, every year.

The system may manage the establishment and ongoing maintenance of trusted relationships. For example, various components relating to trust may be maintained and controlled by the workflow process, such as: legal documents, certification documents, inspection results, audit information, approvals for specific actions regarding individual assets or groups of assets, and supply chain processes.

The administrative control of server 202 may be responsible for issuing asset IDs to trusted suppliers. Asset IDs may be issued manually via an Internet interface or via electronic transaction. Asset IDs may be issued either individually, as a list of asset IDs, or as a defined domain or range of asset IDs for use by a particular supplier. Once an asset ID is assigned, the asset ID may be linked to a specific chain of custody record created and stored in the load module 102. Once an asset ID is linked to a specific record, the asset ID may be used to update, monitor and manage chain of custody information relating to the asset, and the specific record may be accessed by various users (e.g., suppliers, distributors, sellers) to review the related information. Linking an asset ID and specific record may be performed when the asset ID is issued, or at a later time via a manual, web or electronic transaction by an authorized user. Typically the specific record information may be provided by other electronic systems or extracted from paper records when chain of custody management is integrated onto system 100 after the asset has been acquired or during some part of the production of a product from a particular asset. The system may maintain a record of all allocated IDs and ensures uniqueness and security throughout the entire supply chain. For example; when a barcode tag is used, the system may administer barcode tag issuing and invoicing, expiration of asset barcode tags, company anchoring, supply chain control point anchoring, and fraud detection.

Administrative control of asset ID assignment and specific record creation may vary from application to application. For example, an individual manufacturer may act as administrative control. Similarly, an industry association, government agency, or global standards organization may act as administrative control. If an individual manufacturer acts as administrative control, they may assign an asset ID to a single asset (or a collection of assets) and distribute this asset ID to all suppliers they use in the distribution and production of the asset. If an industry association, government agency, or global standards organization acts as administrative control, particular asset standards or regulations may be applied. The teachings contained herein are applicable to each circumstance as the teachings are scalable to both large and small applications.

Once an asset ID is assigned for a product and the specific record is created, various supplier devices may access the modules 204 (e.g., mobile module 106) and update the information relating to the asset ID contained in the specific record. Over a communications network, such as the Internet, server 202 connects to wireless access point 206 allowing various wireless devices to access server 202, e.g., laptop 208a, cell phone 208b and PDA 208c. A user of each of these devices may access server 202 and update the specific record for a particular asset at various stages of the chain of custody of the asset. For example, if a foreman is at a logging supplier, and identifies a batch of logs for use in production of a certain product, the foreman may use his PDA 208c to access the specific record(s) for the asset ID(s) associated with the batch of logs and update the chain of custody information for the assets to indicate the assets are to be distributed accordingly for production. Similarly, a transportation company may use a wireless device such as cell phone 208b to update the asset specific record stored by accessing modules 204, updating chain of custody information relating to the transport of the wood, or the product itself. Computer 210 may also be used by a supplier to access server 202 and update the information as well.

It should be noted that several of the data entries may occur in a location where mobile access to server 202 is limited or not available (e.g., a remote forest). In these situations, a user (e.g., a supplier) may access applications stored on their mobile device (e.g., laptop 208a), then synch this information at a later time when access to server 202 is available. This provides a higher level of mobility and portability over existing systems as the decision making process for the handling of an asset may be extended beyond areas where wireless communications are available to any area where the user can take their mobile device. Mobile devices (e.g., laptop 208a or PDA 208c) may contain both a subset of asset data arid asset management rules and regulations allowing remote users to make informed decisions regarding asset management, transport and transformation when not connected to a communication network. Provided the mobile device is small such as a PDA, the user may be able to take the mobile device virtually anywhere to access information and make a decision related to an asset. Similarly, if a mobile device is not connected to a communication network when a software update is pushed, the mobile device may be synched, loading the software update at a later time.

Along the production process, suppliers may access server 202 and the various modules 204 to update the information contained in the asset specific record. Similarly, alerts may be issued by audit module 108 to various devices connected to server 202 indicating a message relating to a specific asset, allowing a user to review any related reports and update the asset specific record accordingly to acknowledge the alert. This ensures once an asset has been produced and is potentially available for sale, the asset specific record accurately reflects all product origin and chain of custody information and alerts relating to the asset.

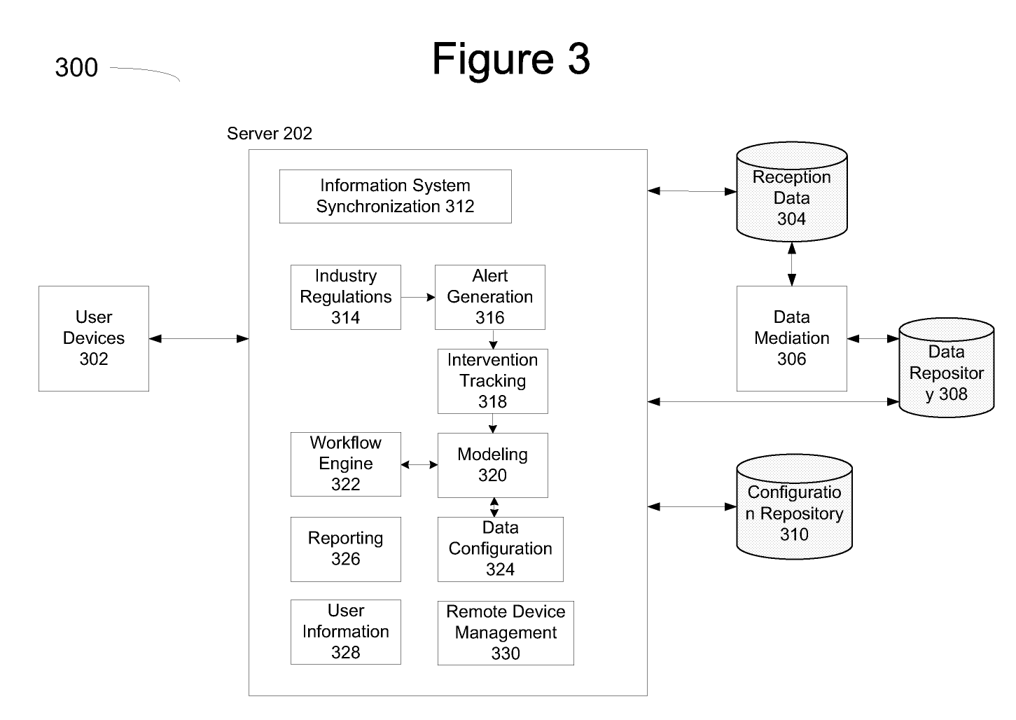

FIG. 3 illustrates an exemplary view of a detailed system 300 for use in a data network for monitoring and managing chain of custody information. In one embodiment, system 300 may enable the collection and management of large volumes of data acquired from disparate locations throughout an entire supply chain. At each location, various user devices 302 may be used to collect data, and asset attributes may be determined based upon previously acquired chain of custody information and models, or newly created based upon historically collected data in the event of a new asset.

As discussed above, various modules and components of the system may be integrated onto a single server, or distributed across several servers communicating via a data network. In exemplary system 300, a majority of the components are integrated onto server 202. Server 202 is in communication with user devices 302 as well as a series of databases: reception data database 304, data repository database 308 and configuration repository database 310. These databases may be centrally located on a single computer readable medium, integrated into memory stored in server 202, or at other various locations through a data network.

Reception data database 304 may be configured to store asset data exactly as it is received in raw form from user devices 302. This information may be processed by data mediation 306 which transforms the raw data into data suitable for long term storage via a mediating data model. Once the asset data is transformed, the transformed data is compiled into the asset record and stored in data repository 308. Subsequently, applications and modules embedded on server 202 can access the stored asset records and manipulate the records accordingly.

Configuration repository database 310 may include various components for use in setting up, customizing and maintaining the system 300. For example, configuration repository database 310 may store rules definitions and industry sector regulation frameworks, user credentials, security roles, process models, data molecules, issues, incidents, alerts, and a listing of authorized remote devices and related information. Data molecules may be a composite set of asset data along with associated metadata that may be processed as a unit in the context of a supply chain model.

Server 202 may function as a centralized hub, operably connected to both user devices 302 and various databases 304, 308 and 310. One component of server 202 may be information system synchronization components 312. These components 312 may be configured to allow the transfer of asset record data to user devices 302, as well as retrieve any collected asset information from the user devices. The components 312 may be programmed to operate over a variety of communications networks including, but not limited to, Internet, virtual private network, satellite based communication networks, and any other wireless data transfer networks.

Another component is industry regulations component 314. Component 314 may provide a mechanism to translate industry sector regulatory rules and best practices into compliance rules for the supply chain. Such regulatory frameworks may include government legal requirements, industry sector best practices, and industry sector rules of certification. These rules may be stored in a rules library on database 310.

Another component may be alert generation component 316. Component 316 may process-asset information in real-time or on a scheduled basis, and examines local or distributed conditions across the entire supply chain. These conditions are compared against the rules library to verify the asset information, and if needed, alert a user to any information which cannot be verified. Intervention tracking component 318 may handle any incoming responses to user alerts. Escalation and delegation of any alerts may be handled by component 318.

Modeling component 320 may create the actual model of the supply chain based on the various riles and any user set guidelines. The supply chain may include various nodes, branches, asset transformation information and associated data as required at each node. Component 320 may be optimized to support supply chain models by producing a graphic representation of supply chain steps for viewing by a user in the view module 104 discussed above. Workflow engine component 322 and data configuration component 324 may function in concert with modeling component 320. Workflow engine component 322 may support the management of incidents and issues in the context of the supply chain. Specifically, the workflow engine component 322 may take a modeled supply chain and process the asset information through each step of the chain.

Data configuration component 324 may provide functionality for accommodating complex and varying data types and relationships across multiple operating system platforms and devices. Flexible data formats may be supported for all data including units of measure and time stamping. Component 324 provides for capturing data both from both on-line and mobile formats in a unified process. Additional components of server 202 may include reporting component 326, user information component 328 and remote device management component 330. Reporting component 326 may be configured to perform analysis on supply chain asset date and arrange the information into a report as requested by a user. The report may be a visual depiction of the supply chain asset data displayed to the user on a computer display, or forwarded to the user as a computer file the user can access on a computing device at a later time.

User information component 328 may provide a level of security for the system. Using information stored in database 310, component 328 may validate a user, determine the user's role and the associated actions the user may take based upon the role. Similarly, each user may have a language and company associate with them, which user information component 328 may use to further customize a user interface to a specific user.

Remote device management component 330 may manage connections to remote devices, whether static or mobile. Component 330 may manage the upload of data to the remote devices, such as software changes or diagnostic information. Conversely, component 330 may manage the download of asset information from the remote devices.

As illustrated in FIG. 3 and discussed above, various components work in concert to provide a data collection, manipulation and management system in which supply chain and chain of custody information may be monitored and managed for a particular asset. Synchronization, collection, security, modeling, reporting and storing components all function in unison to provide the various functionality and resources provided to a user of chain of custody management system 300 discussed above.

It should be noted the listing of components contained in FIG. 3 is merely given by way of example. Various other components may be included depending on the specific application and desired goals of the system. Additionally, the combination and arrangement of components may vary as well from one application to the next.

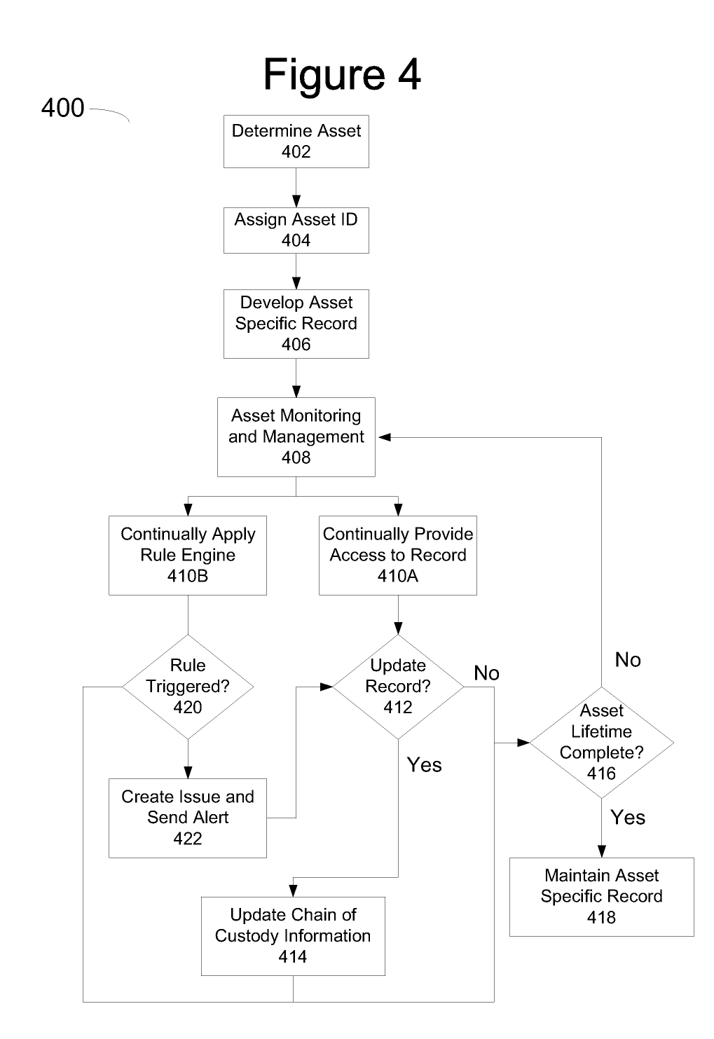

FIG. 4 illustrates an exemplary flowchart showing a sample method 400 for using the system and processes described herein. Method 400 begins when an asset is determined 402. This may occur, for example, when a tree or group of trees is cut down for use in a specific forest. The fallen trees may be determined 402 to be of a high quality, and designated for use in making furniture. After the asset is determined 402, an asset ID is assigned 404 to the asset. As discussed above, the asset ID may be assigned 404 by a centralized authority, or an industry overseer, or an asset supplier. Once the asset ID is assigned 404, an asset specific record is developed 406 and stored in a centralized location. This record will contain any information relating to the chain of custody for the asset.

Once the record is developed 406, the chain of custody monitoring and management system provides asset specific monitoring and management 408. After the monitoring and management 408, the process may split into two parallel paths. The first path may be include providing 410A access to the asset record. When a user accesses the record, depending on the user's role and related permissions, the user may have the decision 412 to update the record. If the user chooses to update the record, the chain of custody information is updated 414. If the use chooses not to update the record, or does not have permission to update the record, the process continues. The user may have the option to view reports relating to the asset record and/or view various other pieces of information stored in the record. Whether the user updates 414 the recorded information or not, the decision 416 may be made as to whether the asset's lifetime it complete. If the lifetime is complete, the asset specific record is maintained 418 for additional user viewing. If the lifetime is not complete, the system continues to monitor and manage 408 the asset record. This provides a dynamic record keeping process throughout the lifetime of the asset, providing constantly updated chain of custody information for monitoring and management.

In parallel to the above discussed path, a second path may exist where the monitoring and management system continually applies 410B a rules engine. During the rules engine being applied 410B, incoming information related to the specific asset record is monitored and compared to existing rules for governing information relating to the asset. The rules engine may detect and take action on supply chain conditions at a specific point in the supply chain, or on conditions or trends distributed across the entire supply chain. It is possible to oversee single assets, groups of related assets, or processes that apply over the entire supply chain. If during this monitoring a rule is determined to have been triggered 420, an issue may be created indicating the triggered rule and the alert may be sent 422 to one or more authorized users. After reviewing the alert, the user may decide to update 412 the record. As before, if the user chooses to update the record the record is updated 414 and it is determined if the lifetime of the asset is complete 416. If the lifetime is complete, the asset specific record is maintained 418. Otherwise, the process returns to asset monitoring and management 408.

It will be appreciated that the above described systems and methods are providing for exemplary purposes only, and may be expanded to include or cover additional embodiments. For example, the area of production may include drug manufacture, agricultural suppliers (e.g., “agribusiness”), furniture or other goods manufactured from processed lumber, and any other area of industry that may lend itself to asset chain of custody information monitoring and management. Similarly, the hardware components of the systems described above may vary from application to application. For example, the communication networks used may vary between public and private networks, the databases used may contain additional information including information pertaining to registered users, and additional areas of information (e.g., a government regulation authority) may be linked to in the asset specific report information.

It will also be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for monitoring and managing chain of custody information for an asset or a group of assets through various stages of asset transport or transformation, the system comprising:
a server configured to assign an asset identifier relating to each specific asset;
an asset record stored on a computer readable medium and linked to the asset identifier, the record configured to store data linked to a specific asset as the asset moves through various stages of asset transport or transformation;
a series of modules, each module stored on a computer readable medium, the modules comprising instructions configured to instruct a processor to access and modify the asset record as well as to establish a series of rules for managing the asset; and
at least one supplier computing device operably connected to the server, the computing device configured to access at least one of the series of modules, thereby allowing a user of the supplier computing device to access and modify the asset record.

2. The system of claim 1, wherein the supplier computing device comprises at least a subset of the series of rules such that the user of the supplier computing device can enter information relating to an asset then the supplier computing device is not operably connected to the server.

3. The system of claim 1, wherein the series of modules comprises a load module, a view module, a mobile module, a configurator/author module and an audit module.

4. The system of claim 3, wherein the audit module comprises instructions configured for providing real time alerts based upon a comparison of the rules for managing the asset and any incoming or stored data relating to activities involving the asset.

5. The system of claim 4, wherein the alerts are sent to the at least one supplier computing device indicating which rule triggered the alert.

6. The system of claim 3, wherein the load module comprises instructions configured for importing data, data verification, data synchronization and data transformation.

7. The system of claim 3, wherein the view module comprises instructions configured for accessing the server, accessing web based forms, organizing assets, managing asset related documents, and producing a report based upon the asset record.

8. The system of claim 3, wherein the mobile module comprises instructions configured for data capture from a mobile device, providing access to the view module via a mobile device and pushing software updates to a mobile device.

9. The system of claim 8, wherein the supplier computing device communicates directly with the mobile module.

10. The system of claim 3, wherein the configurator/author module comprises instructions configured for defining user roles, determining a language and establishing a format for forms and reports.

11. The system of claim 1, wherein the series of modules is stored on the server.

12. The system of claim 1, wherein the supplier computing device is a wireless device connected to the server via a wireless data communications network.

13. A method of monitoring and managing chain of custody information for an asset or a group of assets through various stages of asset transport or transformation, the method comprising:
assigning an asset ID to each asset;
linking an asset record to the asset ID, wherein the asset record is stored on a computer readable medium and configured to store data linked to a specific asset as the asset moves through various stages of asset transport or transformation;
accessing the asset record via a view module, wherein the view module is a set of instructions stored on a computer readable medium configured to instruct a processor to perform a specific task;
managing the asset record via an audit module, wherein the audit module is a set of instructions stored on a computer readable medium configured to provide real time alerts based upon a comparison of a series of rules for managing the asset and any incoming or stored data relating to activities involving the asset;
updating the asset record via the view module; and
accessing and viewing the updated asset record via the view module.

14. The method of claim 13, wherein a load module is configured to link an asset record to the asset ID and store the record.

15. The method of claim 14, wherein the accessing the asset record further comprises accessing the view module via a mobile module configured to communicate with a mobile device via a communications network.

16. The method of claim 14, wherein the view module, the load module, the mobile module and the audit module are stored on a computer readable medium integrated in a server.

17. The method of claim 13, further comprising a supplier computing device configured to update the access record.

18. The method of claim 17, wherein the supplier computing device is a wireless device connected to the server via a data communications network.

19. The method of claim 18, wherein the supplier computing device comprises at least a subset of the series of rules such that a user of the supplier computing device can enter information relating to an asset when the supplier computing device is not operably connected to the data communications network.
